(19) United States
(12) Patent Application Publication
(10) Pub. No.: US 2008/0177659 A1
(43) Pub. Date: Jul. 24, 2008

(54) SYSTEMS AND METHODS FOR PROVIDING FINANCIAL PROCESSING IN CONJUNCTION WITH INSTANT MESSAGING AND OTHER COMMUNICATIONS

(76) Inventors: Timothy Douglas Lacey, Dublin, OH (US); Ravi Acharya, Philadelphia, PA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/833,709

(22) Filed: Aug. 3, 2007

Related U.S. Application Data
(60) Provisional application No. 60/885,834, filed on Jan. 19, 2007.

(51) Int. Cl. G06Q 40/00; G06F 17/30; G06Q 30/00

(52) U.S. Cl. 705/42

(57) ABSTRACT

The invention provides a system and method for providing financial processing in conjunction with instant messaging (IM) to a user using a user device, the system including an IM bank processing portion that is provided to conduct chat sessions with users using IM so as to receive financial information from and provide financial information to the users, and the IM bank processing portion providing for effecting a transaction upon a request of a user; and the IM bank processing portion monitoring activity of the user relating to input of the user vis-à-vis IM chat windows displayed on the user device, the IM bank processing portion effecting the transaction based on the monitoring. The invention might also be used in conjunction with communication technologies other than IM. The invention may be utilized in conjunction with other user to user communication systems, i.e., other than instant messaging.

### RELATED APPLICATIONS

This application claims priority to U.S. Provisional Patent Application 60/885,834 filed Jan. 19, 2007 entitled “Systems and methods for providing financial processing in conjunction with instant messaging and other communications”, which is incorporated herein by reference in its entirety.

### BACKGROUND OF THE INVENTION

Instant Messaging (IM) is a growing market across a wide cross section of persons. For example, teenagers IM more than they e-mail. The “below 25” age groups are major IM Users. Further, studies show that fifty million plus adults trade instant messages and one quarter of those swap IMs more frequently than e-mail. IM is gaining in the workplace too. Further, major vendors are creating products based around IM.

Instant messaging ((IM) is a type of communications service that allows a user to create a type of private chat room with another user. The two users are thus provided with the ability to communicate in essentially real-time over the Internet, or some other network. Thus, IM is somewhat like a telephone conversation, but uses text-based communication, i.e., typed text, instead of voice-based communication. The particular time that typed text is seen by the other user may vary between different IM systems. For example, the other person might be able to see typed text immediately, or alternatively, only once a new line is started, for example.

An IM system may provide for alerting users of which other users are online and available to chat. Once a user can identify what other users are online, a chat session can be initiated between such users. Some IM systems allow for a user to be alerted once a particular other user has become available.

As is well known in the art, a variety of vendors provide IM services. Different products may well be associated with different features and functionalities.

In one arrangement as shown in FIG. 4, an “IM system” includes what is herein referred to as “IM user programs” and an “IM service”. Each user is provided with an IM user program. For example, the IM user program for a particular person might reside on that user's computer, or in some other manner be accessible for that user. For example, the IM user program might reside on a server, to which the user can access and use. The IM user programs (for each user) interface with the IM service, such that communications are sent from one IM user program to another IM user program using the IM service.

FIG. 4 shows one arrangement of a known IM system 10. As shown, the IM system 10 includes an IM service portion 40. The IM service portion 40 provides the IM service and is maintained by a vendor. The IM system 10 further includes a plurality of user's computers (20, 20′, . . . ). As can be appreciated, the particular number of user computers may be in the hundreds or thousands.

As shown in FIG. 4, the IM service portion 40 includes a processing portion 44 and a communications portion 46. The processing portion 44 performs the various known processing associated with providing the IM service. The communications portion 46 of the IM service portion 40 provides for the IM service portion 40 to communicate with the user's computers (20, 20′, . . . ), such as over the Internet 15.

The userone computer 20, as shown in FIG. 4, includes a user interface 22, an IM user program 24, a communication portion 26, and a processing portion 28. The user interface 22 provides for the user to communicate with the userone computer 20. For example, the user interface 22 might include a monitor, keypad, and mouse. The IM user program 24 provides for the IM related processing, including presenting information to userone that is received from another user, and taking information that userone has entered (typed) and outputting such entered information to another user. Various other functionality may be provided by the IM user program 24. The communication portion 26 provides for the userone computer 20 to communicate with the IM service portion 40, as well as with other systems, such as over the Internet. The processing portion 28 performs the various processing, commonly performed by computers, such as data manipulation, storage and retrieval. The userone computers 20′, etc. are of similar arrangement.

While IM is widely used and has a wide variety of benefits, current IM systems fail to address the financial needs of users. The invention addresses this deficiency.

### BRIEF SUMMARY OF THE INVENTION

The invention provides a system and method for providing financial processing in conjunction with instant messaging (IM) to a user using a user device, the system including an IM bank processing portion that is provided to conduct chat sessions with users using IM so as to receive financial information from and provide financial information to the users, and the IM bank processing portion providing for effecting a transaction upon a request of a user; and the IM bank processing portion monitoring activity of the user relating to input of the user vis-à-vis IM chat windows displayed on the user device, the IM bank processing portion effecting the transaction based on the monitoring. The invention might also be used in conjunction with communication technologies other than IM. The invention may be utilized in conjunction with other user to user communication systems, i.e., other than instant messaging.

### BRIEF DESCRIPTION OF THE DRAWINGS

The present invention can be more fully understood by reading the following detailed description together with the accompanying drawings, in which like reference indicators are used to designate like elements, and in which:

FIG. 1 is a block diagram showing an IM financial system in accordance with one embodiment of the invention;

FIG. 2 is a flowchart showing an example of an IM user paying another IM user, in accordance with one embodiment of the invention;

FIG. 3 is a flowchart showing an example of an IM User paying a Payee in accordance with one embodiment of the invention; and

FIG. 4 is an IM system according to known technology.

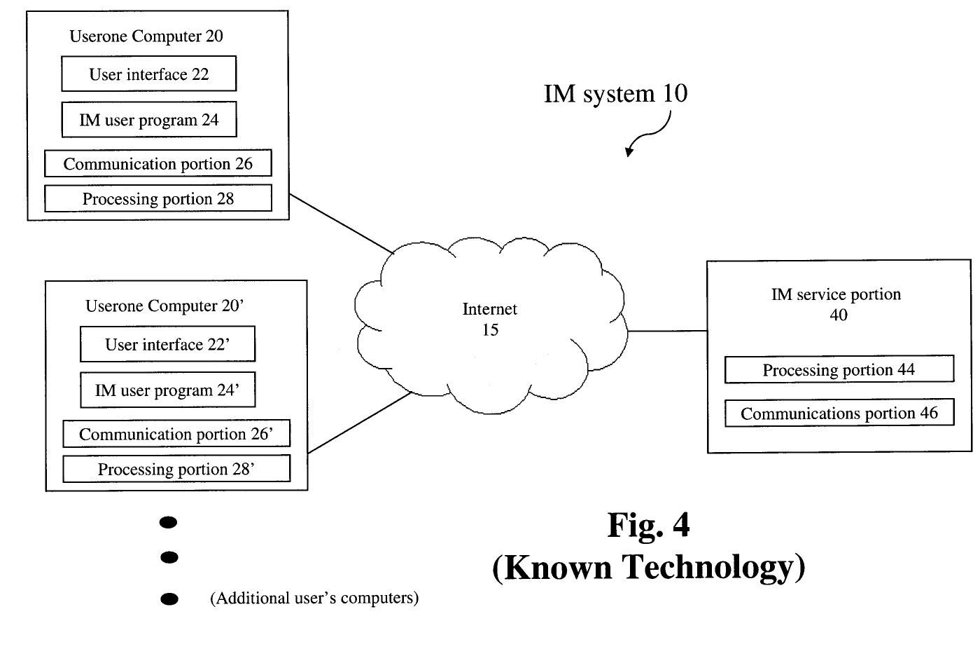

### DETAILED DESCRIPTION OF THE INVENTION

Hereinafter, aspects of the invention in accordance with various embodiments of the invention will be described. As used herein, any term in the singular may be interpreted to be in the plural, and alternatively, any term in the plural may be interpreted to be in the singular.

The invention provides an advantage to IM users by providing an IM Banking solution. In particular, the embodiments of the invention:

1. Add banks to IM products;

2. Creates a secure financial payment session between an IM user and their bank. The process may be provided to follow MFA (Multi-factor Authentication) guidelines.

3. Allows IM users to drag and drop a payment from their bank to either (1) another IM User, or (2) a payee already set up on Chase Online, or some other on-line product, for example;

4. Supplies confirmation information through the IM interface that a payment was made;

5. Leverages existing electronic payment technologies; and

6. Provides a mobile banking interface.

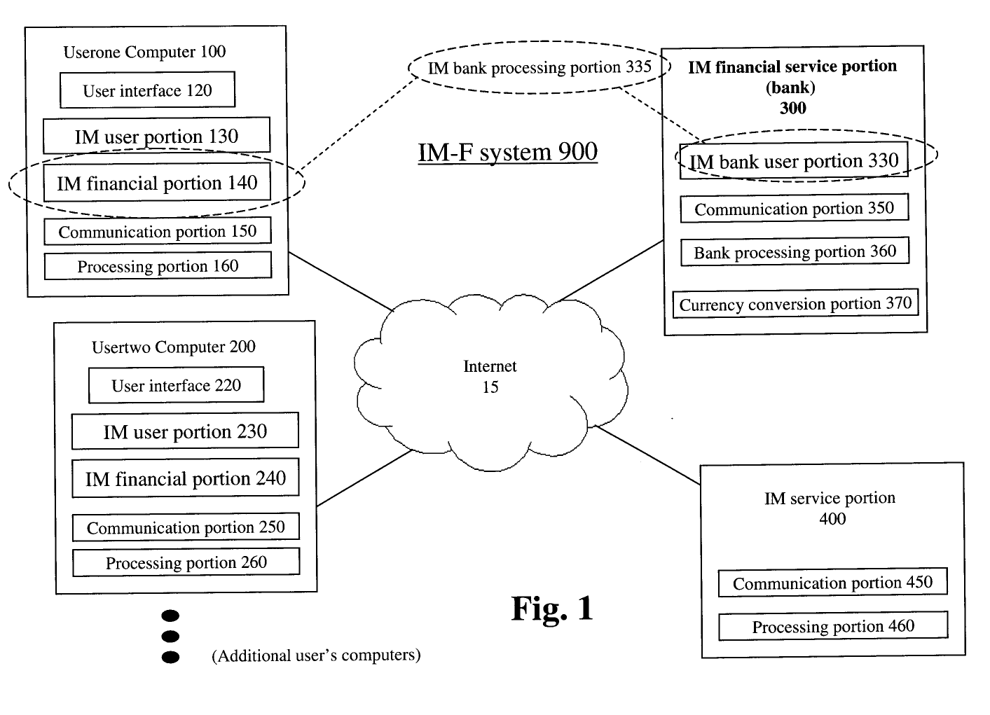

FIG. 1 is a block diagram showing a system in accordance with one embodiment of the invention. As used herein, the embodiment of FIG. 1 might generally be referred to as an Instant Messaging Financial System (IM-F System) 900.

The IM-F system 900 includes a plurality of user's computers (100, 100′, . . . ), an IM financial service portion 300, and an IM service portion 400. As can be appreciated, the particular number of user computers 100 may be in the hundreds or thousands. The IM service portion 400 provides the IM service and is maintained by a suitable vendor. The IM financial service portion 300 provides for various financial processing, as described herein.

As shown in FIG. 1, the IM service portion 400 includes a communication portion 450 and a processing portion 460. The communication portion 450 of the IM service portion 400 provides for the IM service portion 400 to communicate with the user's computers (120, 120′, . . . ) and other systems, such as over the Internet 15. The processing portion 460 performs the various processing associated with providing the IM service, in accordance with one embodiment of the invention.

The userone computer 100, as shown in FIG. 1, includes a user interface 120, an IM user portion 130, an IM financial portion 140, a communication portion 150, and a processing portion 160. The user interface 120 provides for the user to communicate with the userone computer 100. For example, the user interface 120 might include a monitor, keypad, and mouse. The IM user portion 130 provides for the IM related processing, including presenting information to userone that is received from another user, and taking information that userone has entered and outputting such entered information to another user. In accordance with one embodiment of the invention, the IM user portion 130 provides known IM processing/functionality, but is overlayed by the novel processing of the IM financial portion 140 (and functionality provided by the IM financial portion 140). Various other functionality may be provided by the IM user portion 130.

The communication portion 150 provides for the userone computer 100 to communicate with the IM service portion 400, as well as with other systems/users, such as over the Internet. The processing portion 160 performs various processing, such as data manipulation, storage and retrieval. The computers 200 may be of similar arrangement to the userone computer 100.

As noted above, the userone computer 100 also includes an IM financial portion 140. The IM financial portion 140 performs processing in conjunction with the IM user program 130, as described in detail below. In accordance with one embodiment of the invention, the IM financial portion 140 provides a processing layer over the functionality provided by the IM user program 130. This processing layer (provided by the IM financial portion 140) provides a variety a financial related processing performed in conjunction with instant messaging.

As shown in FIG. 1, the IM-F system 900 also includes an IM financial service portion 300. The IM financial service portion 300 is maintained by a bank or some other financial institution. The IM financial service portion 300 includes an IM bank-user portion 330, a communication portion 350, and a bank processing portion 360.

The IM bank-user portion 330 provides for the IM related processing, including presenting information to the IM financial service portion 300 that is received from users, e.g., customers, and taking information that the IM financial service portion 300 has generated, and outputting such generated information to users, i.e., using IM. Various other functionality may be provided by the IM bank-user portion 330, as described below. The communication portion 350 provides for the IM financial service portion 300 to communicate with the IM service portion 400 and the userone computer 100, for example, as well as with other systems, such as over the Internet. The bank processing portion 360 performs various processing, such as financial data manipulation, storage and retrieval of financial data, risk assessment of requested transactions, authentication and verification associated with financial transactions, and various other financial related processing.

In accordance with one embodiment of the invention, the IM bank user portion 330 and the IM financial portion 140 might collectively be characterized as an IM bank processing portion 335, as shown in FIG. 1. This is because the IM bank user portion 330 and the IM financial portion 140 collectively provide the novel financial functionality, as described herein.

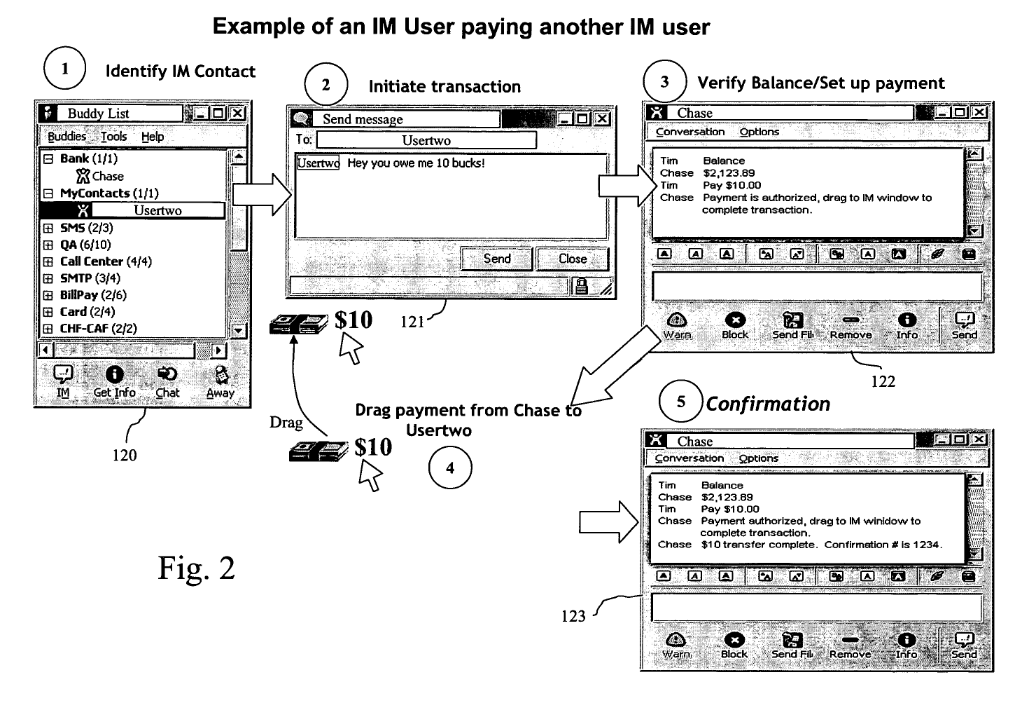

FIG. 2 is a flowchart showing an example of an IM user paying another IM user, in accordance with one embodiment of the invention. For example, the processing of FIG. 2 may be performed by the IM-F system 900, of FIG. 1. In particular, FIG. 2 shows the various windows 120, 121, 122, 123 as seen by userone at the userone computer 100.

As shown in step 1, a human, userone, interfaces with the userone computer 100 (and specifically the IM user portion 130) to prompt the generation of a contact list, e.g., a buddy list, in the user interface 120. From the buddy list, userone selects usertwo to chat with—in an IM session. The human usertwo is disposed at the usertwo computer 200

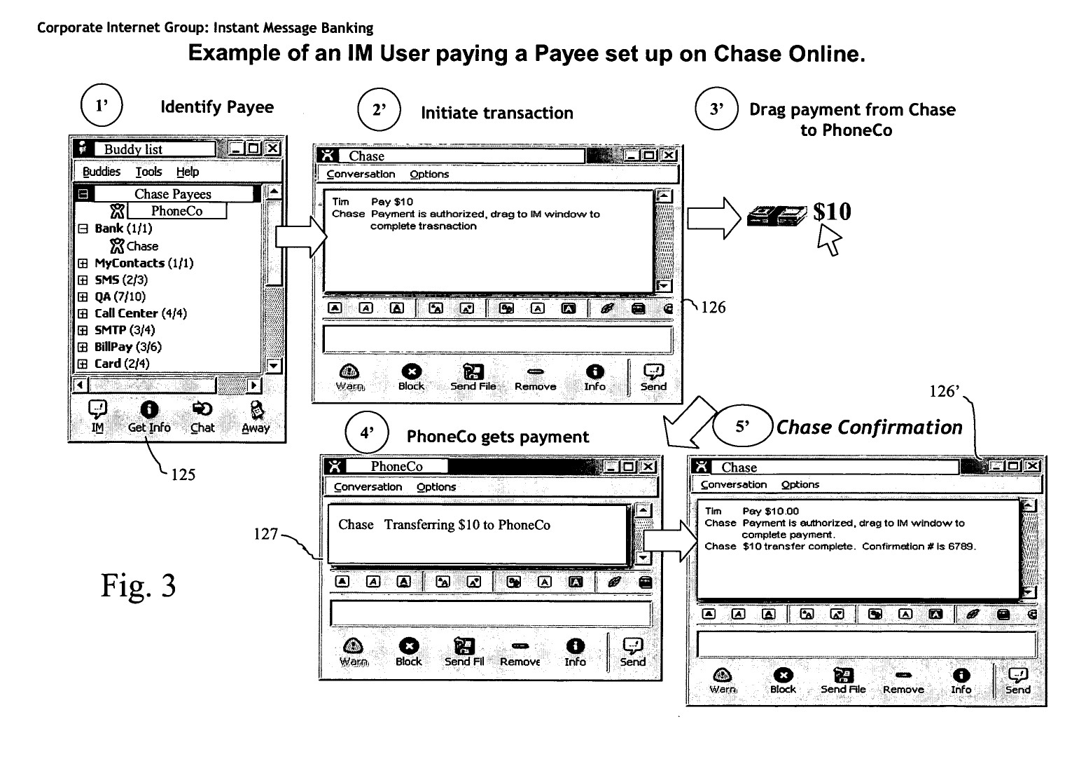

As shown in step 2 of FIG. 3, in the window 121, usertwo has conveyed to userone that userone owes usertwo 10 dollars. As a result, userone decides to go ahead and pay usertwo the 10 dollars that is owed.

To effect the payment from userone to usertwo, userone initiates a further chat session with “Chase”, i.e., the IM financial service portion 300 of FIG. 1, in accordance with one embodiment of the invention. That is, userone selects Chase from the Buddy list of window 120. A chat is thus initiated with the IM financial service portion 300. Thus, userone has an ongoing chat session with usertwo, as well as with the IM financial service portion 300 (Chase).

In the chat session with IM financial service portion 300 (Chase), userone (Tim) types “balance”. In response, the IM financial service portion 300 (via the IM bank user portion 330 and the bank processing portion 360) responds (as a result of receiving the communication from userone and processing the communication) that the balance is $2,123.89. Tim then types “Pay $10”. After such entry is processed by the IM financial service portion 300, the IM financial service portion 300 responds “Payment is authorized, drag to IM window to complete transaction”.

At this point in the process, userone (Tim) “drags” the payment from the Chase window to usertwo's window. This dragging may be performed in any suitable manner. For example, userone might simply click and hold his mouse while the curser is in the Chase GUI (graphical user interface) 122, followed by dragging the curser to the usertwo window, as shown in FIG. 2. In accordance with one embodiment of the invention, once the dragging process is begun (or at some other suitable time such as when the curser leaves the window 122) an icon is generated that visually represents the transaction taking place. For example, as shown in FIG. 2, the icon is a stack of bills that the user drags from the Chase window 122 to the usertwo window 121. This icon may be generated, and the movement thereof may be monitored, by the IM financial portion 140 residing on the userone computer 100. The icon might, in one way or another, represent the transaction such as the amount of the transaction, particular currency, timing, or some other attribute of the transaction, such as if the transaction is money, gold, or lumber, for example.

That is, once the payment has been dragged into the GUI (usertwo window) 121, the IM financial portion 140, in accordance with one embodiment of the invention, communicates this information back to the IM bank user portion 330. Such communication back to the IN bank user portion 330 may be done via an IM channel or in some other suitable manner. The IM bank user portion 330 then communicates this information to the bank processing portion 360. The bank processing portion 360 then actually effects the requested transaction. Once the bank processing portion 360 performs the transaction, the bank processing portion 360 communicates such to the IM bank user portion 330. The IM bank user portion 330 then conveys such information back to the IM user portion 130 via the IM channel. This results in the window 123. That is, the window 123 shows a text line from Chase: “$10 transfer complete. Confirmation number is 1234”. Accordingly, userone now knows that indeed the requested transaction has been completed.

As described above, upon a request from userone, the IM financial service portion 300 (using the IM bank user portion 330 and the bank processing portion 360) responds that the balance is $2,123.89. Further, the above describes other processing performed by the IM bank user portion 330 and the bank processing portion 360, such as effecting and confirming the transaction. In accordance with one embodiment of the invention, the bank processing portion 360 may be thought of as a type of user. That is, information comes in to the IM bank user portion 330 and is forwarded to the bank processing portion 360 for processing. Further, the bank processing portion 360 outputs information to users via the IM bank user portion 330. Thus, in one characterization, the IM bank user portion 330 is the counterpart of the IM user portion 130, and the bank processing portion 360 is the counterpart of the human userone. Indeed, the IM bank user portion 330 may effectively read received text to the bank processing portion 360, and the bank processing portion 360 may effectively type text into the IM bank user portion 330. In this manner, in accordance with one embodiment of the invention, known IM processing may be used, with an inventive overlay providing financial services. For example, the IM user portion 130 may, in one embodiment, effect known IM processing, in conjunction with the IM financial portion 140 providing the novel financial overlay. That is, for example, the IM financial portion 140 may monitor chat sessions between a user (e.g. userone at userone computer 100) and the IM financial service portion 300, in conjunction with providing the capability to effect a transaction by dragging a payment from the Chase window 122 to the usertwo window 121.

The processing of FIG. 2, as illustratively performed by the system of FIG. 1, involves a payment from userone to usertwo of $10. In accordance with one embodiment of the invention, the payment is effected by userone interfacing with the usertwo chat window 121 and the bank chat window 122, in conjunction with a dragging payment action. In one embodiment, the IM financial service portion 300 interfaces with userone via the bank chat window 122 (and exchanges information with userone), in conjunction with the IM financial portion 140 providing the “dragging capability” and reporting the results of any dragged payment back to the IM financial service portion 300.

Other arrangements are of course possible. In general, the invention provides what “looks and feels” like a basic IM platform, but with substantial financial capabilities (as a result of financial processing in the background, such as provided by the IM financial portion 140 and the IM financial service portion 300).

In the example of FIG. 2, a payment is made from userone to usertwo. As can be appreciated, the processing of such a payment between such users generally requires that at least some particulars of the users be known to the IM financial service portion 300 (i.e., the bank). Thus, in accordance with one embodiment of the invention, payment between two users requires that the two users be registered with the IM financial service portion 300, i.e., with the bank. Such registration might involve a party (e.g. userone) providing various information to the IM financial service portion 300 (such as address, telephone, e-mail, account, social security, and IM account information, for example) and the IM financial service portion 300 documenting such information. Thereafter, such user is deemed to be registered. In short, such registration gives the IM financial service portion 300 the information it needs to effect a payment to or from such user/party/customer.

Registration of a user may occur at different times in the process. For example, in the illustrative transaction of FIG. 2, it may be the case that both userone and usertwo are long time customers of the bank 300, and have been registered for years. Alternatively, it may be that userone is a registered customer, but that usertwo is not a registered customer, i.e., upon entering into the process of FIG. 2. In such scenario, the IM financial portion 140 monitors to which user's chat window the payment has been dragged, and determines if that user is a registered user, in accordance with one embodiment of the invention. If the user is a registered user, then no further registration action is needed. However, if the user is not registered, the IM financial portion 140, in accordance with one embodiment of the invention, determines such and takes action to register usertwo (before the transaction can take place).

The IM financial portion 140 may effect the registration of a user in any suitable manner. For example, the IM financial portion 140 (and the IM financial service portion 300) may present a URL to usertwo (to direct usertwo to a registration page) or might e-mail usertwo with instructions as to how to register. The particular manner in which the IM financial service portion 300 pursues registration of usertwo may be varied depending on what information is known. Thus, if no e-mail address is known, then e-mail prompted registration is of course not viable.

Further, it should be appreciated that users participating in transactions, e.g., userone and usertwo, do not need to be customers of the bank 300. Rather, the bank 300 might interface with another banks processing platform to initiate a debit, credit, push, pull, or some other transaction of funds. However, it should be appreciated that some particulars of the users in a transaction be known to bank 300. For example, a transaction to/from a party would generally require an account number of such party, or information by which the account number might be determined/ascertained by either the bank 300 or another bank.

Hereinafter, further features of the invention will be described with reference to FIG. 3. FIG. 3 is a flowchart showing an example of an IM User paying a Payee. In this example, both the user and the business “PhoneCo” have registered with the IM financial service portion (bank) 300. Further, for example, the processing described herein might be used in conjunction with known technology, such as Chase's “CHASE ONLINE” technology. Indeed, the list of payees in window 125 might be down-loaded from some other database, e.g. such as a list of on-line payees.

As shown in FIG. 3, in step 1′, the user identifies a payee from the window 125, resulting in an IM window with the payee. Further, the user initiates an IM window 126 with the bank 300 (Chase), in step 2′. In the IM window 126, Tim has typed that he wants to pay $10. In response, the IM financial service portion 300 has responded that the payment is authorized, and that Tim should drag to the desired IM window to complete the transaction.

In response, in step 3′ Tim indeed drags the transaction (represented by the icon 141) to the PhoneCo IM window 127. In this example, text is then generated in the IM window 127 (by the IM financial service portion 300 and the IM financial portion 140) indicating the $10 is being transferred to PhoneCo.

Further, as shown by the Chase IM window 126′, the IM financial service portion 300 then advises Tim that the transfer is complete, i.e., the IM financial service portion 300 types “$10 transfer complete. Confirmation # is 6789”.

Accordingly, through manipulation of IM windows, the user (here Tim) has easily effected a transaction in an IM environment. The bank (e.g. the IM financial service portion 300) monitors the manipulation of the IM windows and effects requested transactions based on such manipulation)

The invention has been described herein as relating to instant messaging (IM), a type of user to user communication system. That is, one user communicates with another user (or multiple other users). In particular, for example, the processing performed by the IM financial service portion 300 and the IM financial portion 140 is described as providing an overlay over IM, so as to provide various financial related capabilities. However, such novel overlay as described herein is not limited to application in an IM environment. Rather, such overlay may be provided in a video environment, a text messaging environment, or other environments where lines of communications are set up between users, i.e., in other user to user communication systems. That is, the invention is applicable in an environment where discrete lines of communication are established between two users, a user may establish a line of communication with the bank (e.g. the bank 300), and the bank may monitor activity of the user relating to input of the user vis-à-vis the various lines of communication and other users. Such environment is shown in the examples of FIGS. 1-3.

The various embodiments of the invention as described herein may be associated with fraud prevention processing, as is desired, as well as processing to insure what is done was intended to be done. Accordingly, various multi-authentication techniques may be utilized in conjunction with the processing as described above. Further, risk assessment processing might be performed, as desired. For example, risk assessment processing (performed by the bank processing portion 360, for example) might include inputting the dollar amount of the transaction and performing subsequent processing based on that dollar amount. Such might include waiting a longer time to clear a larger transaction, placing a larger transaction over a particular channel, and/or requiring further confirmation from the user for a larger transaction. In accordance with one embodiment of the invention, a particular user might have to input an approval code in order to authenticate/verify the transaction. Further, the reversal of transactions might be provided for in some suitable manner, such as via a suitable dialogue box following an inquiry.

As described above, a transaction is effected by dragging from one IM window to another IM window. For example, FIG. 2 depicts dragging the transaction from the bank IM window to the usertwo IM window (the payee). However, the invention is not limited to such manipulation. Rather, any manipulation or input that is identifiable by the financial services processing system (e.g., the IM financial portion 140) might be utilized. Thus, for example, the userone might click on a particular area in the bank IM window, followed by clicking on the payee's window, so as to tell the IM financial service portion 300 of the transaction. Further, the IM window's might be presented to a user in the form of a “skin.” Such skin might be provided with functionality, e.g. buttons, so as to convey a desired transaction to the IM financial service portion 300.

As described above, in accordance with one embodiment of the invention shown in FIG. 2, userone effects a transaction from an account of userone to the account of usertwo. The IM financial portion 140 and the IM financial service portion 300 effects this requested transaction. However, it is appreciated that the IM financial portion 140 and/or the IM financial service portion 300 may interface with other systems so as to process requested transactions, i.e., other systems may be operating in the background. Accordingly, a suitable interface would be provided between the IM financial service portion 300 and such other systems operating in the background. For example, in order to process transactions, the IM financial service portion 300 might interface with the system described in U.S. patent application Ser. No. 09/448,738 filed Nov. 24, 1999 and entitled “SYSTEM AND METHOD FOR SENDING MONEY VIA E-MAIL OVER THE INTERNET”, Attorney Docket No. 72167.000519, the contents of which are incorporated herein by reference in their entirety.

FIGS. 2 and 3 above show windows as seen by userone. However, usertwo will of course also see his own respective windows. In particular, the IM financial service portion 300 might initiate an IM window with usertwo upon usertwo being selected as a party in a transaction. Accordingly, such communication between the IM financial service portion 300 and the usertwo allows various authentication and/or confirmation as to usertwo.

The systems and method of embodiments as described above may also be implemented and used in a game environment. That is, as described above, the IM financial portion 140 monitors actions by a user (e.g. dragging money) and effects transactions based on such actions. The IM financial portion 140, or an equivalent thereof, may be programmed to monitor a variety of activity, and take action based thereon. Accordingly, events in a game might be programmed to result in certain transactions between players accounts. The players might be enabled to monitor their account as the game progresses. For example, an action by a first player, for a second player, might be programmed to result in a debit to the second player's account and a credit to the first player's account. In accordance with one embodiment of the invention, the invention might be provided to keep track of points in a rewards points environment.

In accordance with one embodiment of the invention, a user effecting a transaction, such as shown in FIG. 2, may be provided with a mechanism to select from a plurality of user accounts. Such might be provided by a suitable dialogue box, for example.

The window 122 of FIG. 2, for example, shows that in response to Tim's inquiry “balance”, Chase responded with the balance amount. In general, it is appreciated that predetermined commands/inquiries might be used by a user to interface with the IM financial service portion 300. Such predetermined commands/inquiries might be decided by bank persons (humans), programmed into the IM financial service portion 300, and conveyed to the users in any suitable manner. Such commands/inquiries might include balance (as described above), last deposit, check 1234 cleared?, most recent ten transactions, overdraft balance, checking balance, and savings account balance, for example.

As described above, payments may be dragged by the user and/or otherwise manipulated. Such manipulation may be presented to the user in a visual manner. As described herein, such visual representation to the user may be done in a manner so as to better convey to the user the transaction that is taking place. Thus, for example, a stack of bills might be proportional in size to the amount being processed, as discussed above. For example, if the transition is in a game environment, as described further below, the visual representation might depict the currency being transacted, e.g., gold or lumber or wild stock, for example.

In accordance with one embodiment of the invention, the IM financial service portion 300 also includes a currency conversion portion 370. The currency conversion portion 370 effects a currency conversion that is used by the IM financial service portion 300. To explain, the bank processing portion 360, as described above, effects a payment from a first person (or entity) to a second person (or entity) using instant messaging, or some other user to user communication system. For example, a user might drag an icon from their IM window to the payee's IM window, so as to convey to the IM financial service portion 300 that the user wishes to effect a payment to such payee.

It is well appreciated that such payments, as well as other payments in embodiments of the invention, may involve a currency conversation. For example, the payer may be in a first country using a first currency, while the payee is in a second country using a second currency. Accordingly, it is needed that the IM financial service portion 300 effect a currency conversion in conjunction with performing the requested transaction.

In accordance with one embodiment of the invention, each user is assigned a currency. This assignment might be performed in conjunction with the registration of a user, for example. Thus, when processing a transaction for a user, the IM financial service portion 300 uses the particular currency that the user is assigned. Alternatively, the particular currency of the payer and payee may be selected in conjunction with requesting the transaction. For example, the IM window of the payee and/or the payer may have an icon (or other indicia) representing the currency options. In requesting the transaction, the requestor may select such icons so as to designate which currency/currencies to work with. In general, in accordance with embodiments of the invention, the payer and the payee may be prompted or advised in any suitable manner what particular currency/currencies should be used in processing the transaction.

Once the particular currencies have been identified (i.e., and the particular conversion that is needed is known), the IM financial service portion 300 retrieves or calculates the needed conversion factor. For example, the IM financial service portion 300 might retrieve the conversion factor from a suitable database. Thereafter, the IM financial service portion 300 performs the requested transaction using the retrieved or calculated conversion factor. The particular needed conversion factor might be retrieved once daily (or in some other periodic manner) or may be retrieved in real time, as is desired, for example.

In accordance with one embodiment of the invention, a user (payer or payee) may be provided with the option of choosing the particular currencies (out of a number of currencies available for use). For example, a payee may receive payments in two (or more) currencies. Thus, the payer may be provided with the option of which currency the payer wishes to pay in. The payer might be provided (via a dialogue box or via IM chat with the IM financial service portion 300, for example) with the conversion rates (and the associated amounts that are calculated based on the conversion rate). The payer, for example, may then see which currency is most favorable to them, and pick such currency. Thereafter, the payment is processed using the selected currency.

Further, the conversion between currencies, as described above, is not limited to national currencies, i.e., Yen, Euros, Dollars, Pesos, etc. Rather, such described “currency” also includes rewards points or any other quantitative asset system (including a point system). Thus, for example, the IM financial service portion 300 might convert from reward points to dollars, or visa-a-versa.

Hereinafter, aspects of implementation of the invention will be described. As described above, FIG. 1 shows embodiments of a system of the invention. Further, FIGS. 2 and 3 show various steps of embodiments of the method of the invention. The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the invention.

It is appreciated that in order to practice the method of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

What is claimed is:

1. A system for providing financial processing, in conjunction with a user to user communication system in which one user communicates with another user, the user using a user device, the system including:
a bank processing portion that is provided to conduct communications with users using the user to user communication system, so as to receive financial information from and provide financial information to the users, and the bank processing portion providing for effecting a transaction upon a request of a user; and
the bank processing portion monitoring activity of the user, relating to input of the user vis-à-vis user to user communications generated by the user device, in the course of communications with the another user, the bank processing portion effecting the transaction based on the monitoring of the communications between the user and the another user.

2. The system of claim 1, wherein the user to user communication system is an instant messaging system.

3. A system for providing financial processing, in conjunction with instant messaging (IM), to a user using a user device, the system including:
an IM bank processing portion that is provided to conduct chat sessions with users using IM so as to receive financial information from and provide financial information to the users, and the IM bank processing portion providing for effecting a transaction upon a request of a user; and
the IM bank processing portion monitoring activity of the user relating to input of the user vis-à-vis IM chat windows displayed on the user device, the IM bank processing portion effecting the transaction based on the monitoring.

4. The system of claim 3, wherein the user device is a computer, and the IM chat windows are generated and presented by the computer, the chat windows including (1) a chat session window between the user and a bank, and (2) a chat session window between the user and another user.

5. The system of claim 4, wherein the activity of the user that is monitored includes the user dragging a payment from the chat session window between the user and a bank to the chat session window between the user and another user.

6. The system of claim 5, wherein the dragging the payment includes the graphical generation of an icon depicting the activity.

7. The system of claim 6, wherein the icon is representative of the transacted funds.

8. The system of claim 7, wherein the icon reflects at least one selected from the group consisting of the currency that is being transacted and the amount that is being transacted.

9. The system of claim 4, wherein the IM bank processing portion includes:
an IM bank user portion that is disposed on a computer at a bank facility, the IM bank user portion providing for conducting chat sessions with users; and
an IM financial portion that is disposed on the user's computer, the IM financial portion monitoring the activity of the user relating to input of the user vis-à-vis IM chat windows displayed on the user device.

10. The system of claim 9, wherein the IM bank user portion provides a conduit, using instant messaging technology, between users and a bank processing portion, the bank processing portion performing various processing including at least one selected from the group consisting of effecting transactions, checking balances, ascertaining risk associated with transactions, registering users, checking the registration of users, and related processing.

11. The system of claim 9, wherein the IM financial portion and the IM bank user portion are each in the form of a software program.

12. The system of claim 3, wherein the processing of the IM bank processing portion is fully automated.

13. The system of claim 3, wherein the user device is at least one selected from the group consisting of a computer, a land-line phone, a cell phone, a PDA, and a Blackberry.

14. The system of claim 3, wherein the transaction is from a user to a corporate payee.

15. The system of claim 14, wherein the IM bank processing portion provides for the downloading of a list of corporate payees for display in a window on a user computer.

16. The system of claim 15, wherein the list of corporate payees is pulled from a database containing online payees.

17. A method for providing financial processing in conjunction with instant messaging (IM) to a user using a user device, the method including:
an IM bank processing portion conducting chat sessions with users using IM so as to receive financial information from and provide financial information to the users;
the IM bank processing portion providing for effecting a transaction upon a request of a user; and
the IM bank processing portion monitoring activity of the user relating to input of the user vis-à-vis communications with another user generated on the user device, the IM bank processing portion effecting the transaction based on the monitoring.

18. The method of claim 17, wherein the communications are in the form of IM chat windows.

19. The method of claim 18, wherein the monitoring includes monitoring dragging operations performed by the user, as displayed on the user computer.

20. A system for providing financial processing, in conjunction with instant messaging (IM), to a user using a user device, the system including:
an IM bank processing portion that is provided to conduct chat sessions with users using IM so as to receive financial information from and provide financial information to the users, and the IM bank processing portion providing for effecting a transaction upon a request of a user; and
the IM bank processing portion monitoring activity of the user relating to input of the user vis-à-vis IM chat windows displayed on the user device, the IM bank processing portion effecting the transaction based on the monitoring; and
wherein the activity of the user that is monitored includes the user dragging a payment from the chat session window between the user and a bank to the chat session window between the user and another user;
wherein the dragging the payment includes the graphical generation of an icon depicting the activity;
wherein the IM bank processing portion includes:
an IM bank user portion that is disposed on a computer at a bank facility, the IM bank user portion providing for conducting chat sessions with users; and
an IM financial portion, the IM financial portion monitoring the activity of the user relating to input of the user vis-à-vis IM chat windows displayed on the user device; and
wherein the IM bank user portion provides a conduit, using instant messaging technology, between users and a bank processing portion, the bank processing portion performing various processing including at least one selected from the group consisting of effecting transactions, checking balances, ascertaining risk associated with transactions, registering users, checking the registration of users, and related processing.

21. The system of claim 20, wherein the IM bank processing portion performs a currency conversion in effecting the transaction.

22. The system of claim 21, wherein the IM bank processing provides for the user selecting at least one of the particular currencies used in the transaction.
